(19) United States
(12) Patent Application Publication
(10) Pub. No.: US 2010/0326625 A1
(43) Pub. Date: Dec. 30, 2010

(54) Method and Apparatus for Determining the Balance of Cooling Air in a Conditioned Space with ICT Equipment

(75) Inventors: Jacobus Hermanus Jozeph Slegten, Wijhe (NL); Tjark Ernst van Dijk, Zeewolde (NL); Cornelis Prins, Oldebroek (NL); Robbert Mees Lodder, Den Hoorn (NL)

Correspondence Address: SWANSON & BRATSCHUN, L.L.C., 8210 SOUTHPARK TERRACE, LITTLETON, CO, 80120, US

(73) Assignee: UPTIME PRODUCTS B.V., Schiedam (NL)

(21) Appl. No.: 12/773,657

(22) Filed: May 4, 2010

Related U.S. Application Data
(63) Continuation-in-part of application No. PCT/NL2010/050141, filed on Mar. 17, 2010.

(30) Foreign Application Priority Data
Mar. 17, 2009 (NL) 2002633

(51) Int. Cl. F24F 7/00; G01F 7/00

(52) U.S. Cl. 165/59; 73/196

(57) ABSTRACT

A method for determining the balance between an amount of supplied cooled air and an amount of discharged heated air in a temperature- and air humidity-conditioned space in which ICT equipment is disposed which gives off heat to passing cooled air so that this air is heated up, wherein the free movement of a reference stream of air in the space is monitored by measuring a signal which is imparted to the air of the reference stream with the aid of a signal source. The invention further relates to an apparatus for determining the balance between an amount of supplied cooled air and an amount of discharged heated air in a temperature- and air humidity-conditioned space in which ICT equipment is disposed which gives off heat to passing cooled air so that this air is heated up, comprising a measuring tube for monitoring the movement of a reference stream of air.

### RELATED APPLICATIONS

This application is a continuation-in-part of International Application No. PCT/NL2010/050141, filed Mar. 17, 2010, which claims priority to Netherlands Application No. 2002633, filed Mar. 17, 2009, each of which is incorporated herein by reference in its entirety.

### TECHNICAL FIELD

The invention relates to a method and apparatus for determining the cooling air balance in a conditioned space. In particular, the invention relates to a method and apparatus for determining a balance between an amount of supplied cooled air and an amount of discharged heated air in a temperature- and air humidity-conditioned space in which ICT equipment is disposed which gives off heat to passing cooled air so that this air is heated up.

### BACKGROUND

ICT equipment is often disposed in so-called server rooms or datacenters, where the ICT equipment is disposed in so-called server racks. This ICT equipment generates much heat requiring cooling of the ICT equipment to ensure reliability and longevity. Cooled air is supplied at the front of the server racks. An aim is then to condition specific parameters of the cooled air, such as temperature and air humidity, in accordance with predetermined guidelines, for example, as described in “Thermal guidelines for data processing environments” of the American Society of Heating, Refrigerating and Air-Conditioning Engineers (ASHRAE). The supplied cooled air is drawn in by the servers themselves, guided along the heat-emitting components, and blown out in heated condition at the rear of the server rack. The heated cooling air is often recirculated and may, for example, be recirculated internally in the space and be cooled, but may also be recirculated via a cooling device arranged externally of the space.

Usually, on the basis of the required cooling capacity for the ICT equipment disposed in the space, a calculation is made of the amount of cooled air to be supplied, and the supply and discharge of air is regulated, for example, on the basis of the temperature of the cooled air and/or the heated air.

Ideally, however, precisely as much cooled air is supplied as is drawn in by the ICT equipment. In such a situation, optimum cooling of the ICT equipment takes place, and cooled air will be optimally heated up by the ICT equipment.

If there is too little supply of cooled air, air can flow along the server racks in the direction opposite to the cooled air. This can result in recirculation of already heated cooled air which is again drawn in by the ICT equipment. This can adversely affect the functioning and the life of the ICT equipment.

If there is too much supply of cooled air, the air stream is forced through the server racks. This is also bad for the functioning and for the life of the ICT equipment. In addition, this reduces the efficiency and the capacity of the cooling system.

In practice, such a balance situation is very difficult to achieve, for one thing because the amount of cooled air drawn in by the server racks is relatively small. The pressure drop across the ICT equipment is so small that measurement is easily disturbed when, for example, a door in the server space is opened and closed. Furthermore, the air flow over the ICT equipment is also very slight.

### SUMMARY

Disclosed are a method and an apparatus with which determining the balance between the amount of supplied cooled air and the amount of discharged heated air can be carried out in a simple and reliable manner. A first aspect of the disclosure is a method for determining a balance between an amount of supplied cooled air and an amount of discharged heated air in a temperature- and air humidity-conditioned space in which, for example, ICT equipment is disposed which gives off heat to passing cooled air so that this air is heated up, wherein the free movement of a reference stream of air in the space is monitored by measurement of a signal which is imparted to the air of the reference stream with the aid of a signal source. By monitoring the free movement of a reference stream on the basis of a signal imparted to the reference stream, an accurate picture of the air flow can be given in a relatively simple and reliable manner. The signal that is imparted to the air of the reference stream with the aid of the signal source can be produced, for example, in the form of energy. Thus, with a heating element, heat can be delivered to the air to deliver a thermal signal, and the air, for example, can be rendered turbulent to deliver a flow signal. The signal may also be imparted to the air in a different manner, for example, by transfer of particles to the air, such as moisture, smoke, ions or gas particles for marking. Measuring the signal can then comprise determining a measuring value, but may also comprise only detecting the presence of the signal.

The reference stream can flow through a measuring tube in which the signal is imparted to the reference stream with the aid of the signal source. The measuring tube may be placed, for example, with an inflow opening at the front of ICT equipment in a server rack, and with an outflow opening at a rear of the ICT equipment in the server rack. For determining the balance between the amount of cooled air supplied to the space and the heated air discharged from the space, possibly a single measuring tube can suffice. However, placing multiple measuring tubes may yet be desirable, for example, for measuring local conditions or as redundancy.

By measuring the signal in the reference stream at a flow distance from the source, a first determination of the free movement of the air stream may be done. When no signal is detected, this may be used, for example, as an indication that the reference stream is indeed moving away from the measuring point. By measuring the signal both upstream and downstream of the source in the reference stream, the flow direction can be determined more reliably. By comparing the values measured upstream and downstream, the flow direction can be determined and possibly the flow rate can be calculated.

By comparing the measured signal with a calibration value, a more accurate determination can be done. Such a calibration value can be measured elsewhere in the space, or may be assumed as a given. By measuring the calibration value further upstream in the reference air stream in a calibration measurement, accuracy can be further augmented. Preferably, such a calibration measurement also takes place in the measuring tube, for example, near an entry thereof.

By enlarging the strength of the signal produced by the signal source when the difference values between the calibration value and the measured signal becomes smaller, the apparatus can also work accurately at higher flow rates.

By reducing the strength of the signal produced by the signal source when the difference values between the calibration value and the measured signal becomes larger, the accuracy of the determination can be preserved at slight flow rates. Preferably, the signal is reduced to a minimum value, which is selected such, for example, that the signal can dissipate naturally in the measuring tube shortly beyond the upstream and downstream measuring points, and before a calibration measuring point, if any.

By regulating the amount of cooled air supplied to the space or the servers and/or the amount of heated air discharged from the space or the servers on the basis of the monitored movement, a very efficient cooling can be achieved. The supply can then be selected to be, for example, a small percentage, e.g., 1 to 2%, greater than the discharge, to ensure a very slow continuous flow-through. When the signal source is then a heating device that gives off heat to the air of the reference stream, and when the measurement of the signal involves a temperature measurement, the balance can be elegantly determined.

Also disclosed is an apparatus for determining the balance between an amount of supplied cooled air and an amount of discharged heated air in a temperature- and air humidity-conditioned space in which, for example, ICT equipment is disposed which gives off heat to passing cooled air so that this air is heated up, the apparatus comprising a measuring tube for monitoring the movement of a reference stream of air.

Elegantly, the measuring tube may comprise a tube through which a reference stream of air can pass freely, a signal source for producing a signal which is imparted to the reference stream of air in the tube, and a sensor disposed in the measuring tube at a flow distance from the source for measuring the signal in the reference stream of air. The measuring tube may then comprise sensors disposed in the tube both upstream and downstream of the source, which are capable of detecting the measuring signal in the stream of reference air. Optionally, a calibration sensor placed upstream of the source may be provided. The calibration sensor may then be included near an entry of the tube.

Elegantly, the signal source comprises a heating device, e.g., a resistance wire, and the sensors are designed as thermal sensors, e.g., thermocouples. The tube may then be made, for example, from thermally insulating material, e.g., plastic. The tube may then, for example, be accommodated in a housing for mounting in a server rack, for example, a so-called 1U 19″ mount. On the front of such a mount, it may be displayed, e.g., via a screen, whether too much, too little or no air is flowing through the measuring tube. Furthermore, any malfunction may be indicated. Also, the local suction temperature may be represented. The housing may be provided furthermore with a data processing unit for processing the measuring data, and with an output unit for outputting the data to a control device.

When new ICT equipment is placed in the space, the apparatus may, for example, automatically self-adjust to a new balance between supplied and discharged air. Data transfer may be optionally wireless from the apparatus to a receiver. In such a case, the apparatus does not need to make use of any network present.

Further advantageous embodiments of the invention are represented in the description of the drawings and the dependent claims.

The invention will be further elucidated on the basis of an exemplary embodiment which is represented in the drawings.

### BRIEF DESCRIPTION OF THE DRAWINGS

FIG. 1 shows a schematic representation of a measuring tube;

FIG. 2 shows a schematic representation of the measuring tube of FIG. 1 with an air flow from left to right in the figure;

FIG. 3 shows a schematic representation of the apparatus of FIG. 1 with a stationary air flow;

FIG. 4 shows the apparatus of FIG. 1 with an air flow from right to left in the figure; and

FIG. 5 shows a schematic representation of a temperature- and air humidity-conditioned space in which ICT equipment is disposed in which a measuring apparatus according to FIG. 1 is included.

### DETAILED DESCRIPTION

Unless otherwise indicated, all numbers expressing quantities of ingredients, dimensions reaction conditions and so forth used in the specification and claims are to be understood as being modified in all instances by the term “about”.

In this application and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

The Figures are only schematic representations of a preferred embodiment of the invention which is given by way of non-limiting exemplary embodiment. In the Figures, like or corresponding parts are represented with the same reference numerals.

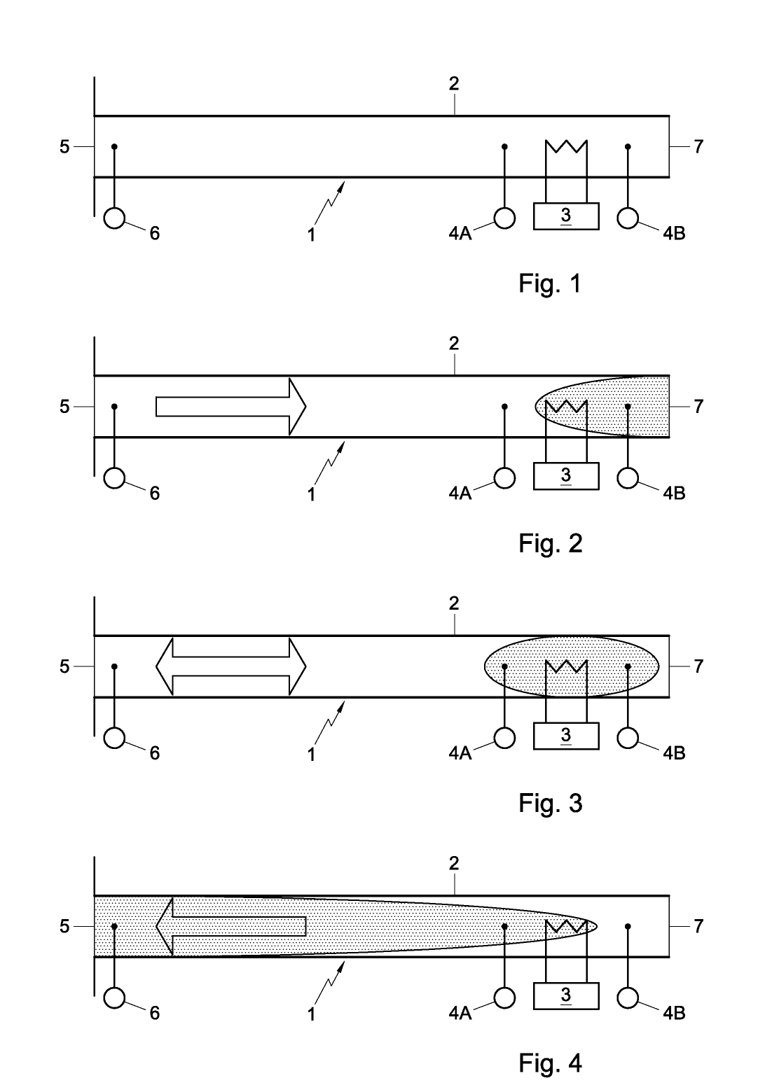

In FIG. 1 a measuring tube 1 is shown. The measuring tube 1 comprises a plastic tube 2 through which a reference stream of air can pass freely. Included in the tube 2 is a signal source 3 capable of imparting to air in the tube a signal that can move along with the reference stream. In this exemplary embodiment, the signal source 3 is designed as a heating resistance. The measuring tube 1 furthermore comprises sensors 4A, 4B disposed in the tube 2 at a flow distance from the signal source 3, which are capable of detecting the measuring signal in the stream of reference air. In this exemplary embodiment, the sensors 4A, 4B are designed as thermocouples, which are respectively disposed upstream and downstream of the signal source 3 in the tube 2. The measuring tube 1 furthermore comprises a calibration sensor 6 disposed near the entry 5 of the tube 2. The sensors 4A, 4B are each situated at an equal space from the signal source 3, and the calibration sensor 6 is situated at a multiple of that distance upstream of the signal source 3 as explained in greater detail below. The tube 2 extends straightly from the entry 5 to an exit 7.

The signal source 3 is preferably configured for locally imparting the signal to the reference stream. Thus, for example, the signal may be generated by locally influencing a physical parameter of the reference stream of air. Also, locally, specific measurable particles may be introduced into the reference stream. By locally inducing a physical disturbance and observing the interaction with the reference stream, the free movement of the reference stream of air can be measured.

In FIG. 2 it is shown that a stream of reference air flows from left to right. The heating element may be controlled such that a constant temperature difference prevails between the calibration sensor 6 and the hotter one of the sensors 4A, 4B. In this case, that is sensor 4B. The constant temperature difference may be small, but is preferably maintained at all times, for example, by variation of the strength of the heating signal.

From the temperature difference between the sensors 4A, 4B, the air speed and the direction of the air stream can be derived.

If the air stream to the right becomes larger, the temperature difference between the calibration sensor 6 and sensor 4B will become smaller, and the heating resistance 3 will be controlled up in delivered power so as to maintain the constant temperature difference. If the air stream to the right increases, the temperature difference between the sensors 4A, 4B will decrease. Based on this, the apparatus can determine the extent of the rise of the speed of movement of the reference stream of air.

If the speed of movement of the air flow to the right decreases, the temperature difference between the calibration sensor 6 and the sensor 4B will become larger, and the heating resistance 3 can be controlled down in delivered power to maintain the constant temperature difference.

The temperature and air humidity of the supplied cooled air can be set within predetermined intervals. Thus, the temperature may be set, for example, between around 20° C. and around 25° C., while the air humidity may be, for example, between around 45% and around 55%.

When the movement of the reference stream of air is very slight, and the heating resistance has reached its minimal heating power, the temperature difference between the calibration sensor 6 and the sensor 4B will decrease further, below the constant temperature difference. At the same time, due to the slight amount of movement of the air stream the temperature difference between the sensors 4A and 4B will become zero. This may for instance be chosen as the point where the amount of supplied cooled air and the amount of discharged heated air are in balance.

In FIG. 3 there is shown that the movement of the stream of reference air is very low or zero. The amount of supplied cooled air and the amount of discharged heated air are in balance. The heating resistance 3 has been controlled down to its minimal power. The difference between the temperature of sensor 4A and 4B is zero and the difference in temperature between calibration sensor 6 and sensors 4A, 4B is minimal. The distance between the calibration sensor 6 and the heating resistance 3 is selected as a multiple of the distance between the sensors 4A and 4B and the heating resistance 3 such that through dissipation of the heat, the heat-up of the heating resistance 3 will not reach the calibration sensor 6, so that the heating resistance 3 is prevented from adjusting the temperature of the sensors 4A, 4B to the same level as the calibration sensor 6.

In FIG. 4 there is shown that the reference stream of air goes from right to left. The heating resistance 3 is so controlled that a constant temperature difference is created between the calibration sensor 6 and the hotter sensor of the sensors 4A, 4B. In this case, that is sensor 4A. The temperature difference is preferably minimal, and is maintained through variation of the power delivered by the heating resistance 3.

From the temperature difference between sensors 4A and 4B, the air speed and the direction of the air stream can be derived. If the air stream to the left becomes larger, the temperature difference between the calibration sensor 6 and the sensor 4A will become smaller. The power delivered by the heating resistance will be controlled up to maintain the constant temperature difference. If the air stream to the left increases, the temperature difference between the sensors 4A and 4B will decrease. The apparatus 1 in this way determines the extent of increase of air speed through the measuring tube 1, and can pass this on to a control device which regulates the supply and the discharge.

If the air flow to the left diminishes, the temperature difference between the calibration sensor 6 and the sensor 4A will become larger, and the power delivered by heating resistance 3 will be controlled down to maintain the constant temperature difference.

When the air flow becomes very slight, and the resistance has reached its minimal power, the temperature difference between the calibration sensor 6 and the sensor 4A will decrease further. At the same time, owing to the very slight air flow the temperature difference between the sensors 4A and 4B will become zero. For the apparatus 1, in this example, this is the point where the air stream is in balance.

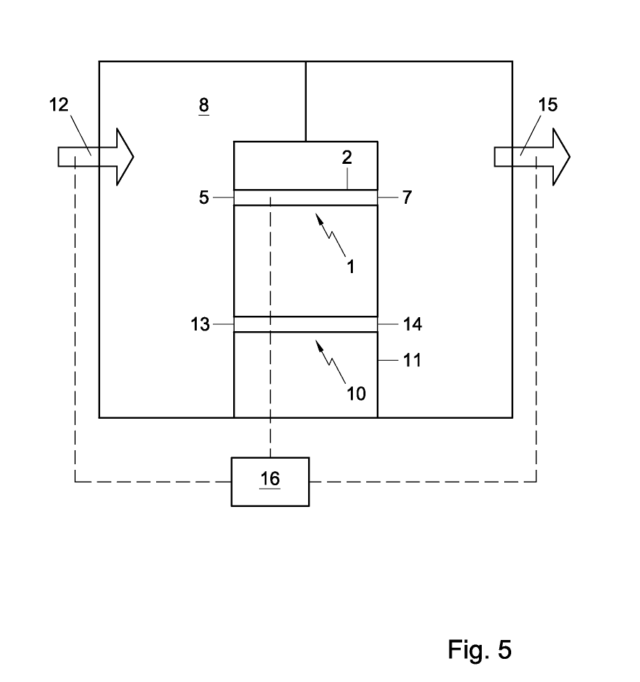

In FIG. 5 there is shown a temperature- and air humidity-conditioned space 8 in which ICT equipment 9 is disposed which gives off heat to passing cooled air so that this air is heated up. In this exemplary embodiment, the ICT equipment is designed as servers 10 which are disposed in a server rack 11. Cooled air is supplied via a supply 12 to the space 8 and in particular to the front 13 of the servers 10 in the server rack 11. The servers 10 independently draw in the cooled air and guide it along the heat-emitting components, and blow out the heated air again at the rear side 14. The heated air is thereupon discharged via a discharge 15 and possibly recirculated after cooling. The amount of supplied cooled air and the amount of discharged heated air is controlled with the aid of control means 16 on the basis of the movement of the stream of reference air monitored with the measuring tube 1.

The invention is not limited to the exemplary embodiment represented here. Many variants are possible within the scope of the invention as set forth in the appended claims.

Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

What is claimed is:

1. A method for determining a balance between an amount of supplied cooled air and an amount of discharged heated air in a temperature- and air humidity-conditioned space in which ICT equipment is disposed which gives off heat to passing cooled air so that this air is heated up, the method comprising:
monitoring the free movement of a reference stream of air in the space by imparting a signal to the air of the reference stream by a signal source and measuring the signal.

2. The method according to claim 1, wherein the reference stream flows through a measuring tube in which the signal is imparted to the reference stream by the signal source.

3. The method according to claim 1, further comprising measuring the signal in the reference stream at a flow distance from the source.

4. The method according to claim 3, further comprising measuring the signal in the reference stream both upstream and downstream of the signal source.

5. The method according to claim 4, further comprising mutually comparing the values measured upstream and downstream.

6. The method according to claim 1, further comprising comparing the measured signal with a calibration value.

7. The method according to claim 6, further comprising measuring the calibration value further upstream in the reference air stream in a calibration measurement.

8. The method according to claim 6, further comprising enlarging the strength of the signal delivered by the signal source when any difference value between the calibration value and the measured signal becomes smaller.

9. The method according to claim 6, further comprising diminishing the strength of the signal delivered by the signal source when any difference value between the calibration value and the measured signal becomes larger.

10. The method according to claim 1, further comprising regulating the amount of supplied cooled air and/or the amount of air discharged from the space on the basis of the monitored movement.

11. The method according to claim 1 wherein the signal source is a heating device which gives off heat to the reference stream of air, and wherein the measuring of the signal involves measuring a temperature.

12. An apparatus for determining a balance between an amount of supplied cooled air and an amount of discharged heated air in a temperature- and air humidity-conditioned space in which ICT equipment is disposed which gives off heat to passing cooled air so that this air is heated up, the apparatus comprising
a measuring tube for monitoring the movement of a reference stream of air.

13. The apparatus according to claim 12, wherein the measuring tube comprises:
a tube through which a reference stream of air can pass freely;
a signal source for delivering a signal which is imparted to the reference stream of air in the tube; and
a sensor disposed in the measuring tube at a flow distance from the source, for measuring the signal in the reference stream of air.

14. The apparatus according to claim 13, wherein the measuring tube furthermore comprises sensors disposed in the tube both upstream and downstream of the source, capable of detecting the measuring signal in the stream of reference air.

15. The apparatus according to claim 13, further comprising a calibration sensor placed upstream of the source.

16. The apparatus according to claim 15, wherein the calibration sensor is included near an entry of the tube.

17. The apparatus according to claim 13, wherein the signal source comprises a heating device, and wherein the sensor is a thermal sensor.

18. The apparatus according to claim 13, wherein the tube is included in a housing for assembly in a server rack.

19. The apparatus according to claim 14, wherein the sensors are an equal distance upstream and downstream from the source.

20. A temperature- and air humidity-conditioned space in which ICT equipment is disposed which gives off heat to passing cooled air so that this air is heated up, comprising a supply of cooled air and a discharge of heated air, an apparatus according to claim 13 and means for balancing the amount of supplied cooled air and the amount of discharged heated air, on the basis of the movement monitored with the apparatus.
